(19) United States
(12) Patent Application Publication
(10) Pub. No.: US 2015/0213935 A1
(43) Pub. Date: Jul. 30, 2015

(54) ARMATURE FOR AN ACTUATOR DEVICE

(71) Applicant: Robert Bosch GmbH, Stuttgart (DE)

(72) Inventors: Alexander Wernau, Blaufelden (DE); Ralph Engelberg, Ditzingen (DE); Wolfgang Braun, Ditzingen (DE); Dirk Schnittger, Ludwigsburg (DE)

(21) Appl. No.: 14/419,578

(22) PCT Filed: Jun. 21, 2013
(86) PCT No.: PCT/EP2013/063029

§ 371 Date: Feb. 4, 2015

(30) Foreign Application Priority Data
Aug. 17, 2012 (DE) 102012214655.5

(51) Int. Cl. H01F 7/08; H01F 7/16

(52) U.S. Cl. CPC H01F 7/081; H01F 7/1607; H01F 2007/086

(57) ABSTRACT

The invention relates to an armature for an actuator device comprising at least one magnet. In order to improve the armature for an actuator device comprising at least one magnet, the outer radial region of said armature (8) is provided with a coating (44).

### BACKGROUND OF THE INVENTION

The invention relates to an armature for an actuator device comprising at least one magnet.

Adjustment devices for adjusting a set piston which acts on the displacement volume of a hydrostatic machine are known from the European patent specifications EP 1 217 209 B1 and EP 1 219 831 B1. The set piston can be moved out of a neutral position, which is predetermined by the force of at least one return spring, between two end positions. A control valve comprising a control piston is provided for regulating set pressures in set pressure chambers. The deflection of the set piston can be transmitted to a spring sleeve as a linear movement via a return lever that is fixedly connected to the set piston, said spring sleeve being operatively connected by means of a control spring. The control piston comprises in the axial direction a first control piston part and a second control piston part, which are connected to one another by a control piston tappet. The first and the second control piston part can be impinged with a force directed towards one another at the ends thereof facing away from each other by respectively at least one centering spring and/or adjusting spring. A control spring is tensioned between two spring seat bodies. The preload of at least one centering spring and/or adjusting spring can be adjusted to generate spring forces that are balanced in the neutral position of the control valve.

### SUMMARY OF THE INVENTION

The aim of the invention is to improve an armature for an actuator device comprising at least one magnet, in particular with regard to manufacturability and/or functionality.

The aim is met for an armature for an actuator device comprising at least one magnet by virtue of the fact that the outer radial region of the armature is provided with a coating. The armature is preferably designed substantially rotationally symmetrical. The rotational axis of the armature preferably corresponds to a longitudinal axis of the armature. In the installed state, the armature can be moved back and forth in the longitudinal direction thereof during operation of the actuator device. The coating on the armature provides the advantage that a sliding film, in particular a Teflon film, can be eliminated between the armature and a pole tube.

A preferred exemplary embodiment of the armature is characterized in that the coating has a constant extension in the radial direction. As a result, a defined radial air gap between armature and pole tube can be provided in a simple manner.

A further preferred exemplary embodiment of the armature is characterized in that the coating is designed as a slide coating. As a result, the friction between armature and pole tube can be reduced during operation of the actuator device.

A further preferred exemplary embodiment of the armature is characterized in that the coating is formed from a friction-reducing material. The coating can be formed from a magnetic or an amagnetic material. The coating can comprise a plurality of layers of different materials. If the coating comprises a plurality of layers, it is sufficient if only the outer coating is formed from a friction-reducing material.

A further preferred exemplary embodiment of the armature is characterized in that the outer radial region of said armature is extrusion-coated with a plastic material. On the one hand, a defined radial air gap can be easily embodied between armature and pole tube by means of the plastic material. Furthermore, the friction between armature and pole tube can be reduced by the plastic material. In addition, the extrusion-coating of the armature can be simply and cost effectively carried out in a plastic injection molding process.

A further preferred exemplary embodiment of the armature is characterized in that the outer radial region of said armature is provided with a metallic layer that contains chrome. The metallic layer can constitute the complete coating of the armature. The metallic layer can however also relate to an outer layer consisting of a plurality of layers which are used to constitute the coating.

A further preferred exemplary embodiment of the armature is characterized in that the outer radial region of said armature is provided with a metallic layer that contains nickel. The metallic layer can constitute the complete coating of the armature. The metallic layer can however also relate to an outer layer consisting of a plurality of layers which are used to constitute the coating.

A further preferred exemplary embodiment of the armature is characterized in that the outer radial region of said armature is provided with the coating over the entire longitudinal extension thereof. The outer radial region of said armature preferably has the shape of a right circular cylinder jacket. For reasons of cost, it can also be advantageous to provide only individual longitudinal sections or circumferential sections with the coating.

A further preferred exemplary embodiment of the armature is characterized in that the outer radial region of said armature has at least one section that is not provided with the coating or encapsulation. As a result, material can be saved during the coating or encapsulating process.

A further preferred exemplary embodiment of the armature is characterized in that the section not provided with the coating or encapsulation is designed, disposed and/or dimensioned such that said section enables a hydraulic balance between two opposite ends of the armature. The hydraulic balance simplifies a motion of the armature during operation. The at least one section without coating or encapsulation creates simply a hydraulic connection between the two ends of the armature. The section can extend in the longitudinal direction. There can also be a plurality of sections that are not provided with the coating or encapsulation. In so doing, care must be taken that sections provided with the coating or encapsulation ensure a sufficient guidance of the armature.

The invention furthermore relates to an actuator device comprising an armature which was previously described and can be moved in a pole tube in a reciprocating manner in the longitudinal direction. The actuator device relates, for example, to an actuator for control and regulation engineering applications. The actuator device can however also comprise an effector that is used in robotics. The actuator device can thereby be designed as an operating device as well as a drive device, for example in a mechatronic application. The actuator device can, for example, be used to drive a fluid machine, in particular a fluid pump. In a particularly advantageous manner, the actuator device is associated with an axial piston machine comprising a swivel cradle that is designed as a pivoting adjustment device. The axial piston machine is preferably disposed in a mobile hydraulic drive that is complementary to a primary drive unit of, for example, an internal combustion engine. The mobile hydraulic drive is preferably disposed in a hydraulic drive train of a hybrid vehicle. The hybrid vehicle preferably relates to a passenger car or a commercial vehicle.

According to a further aspect of the invention, the actuator device is used to embody a control valve in a cooling circuit and/or heating circuit of a motor vehicle. In order to embody a cooling circuit valve or a heating circuit valve of a motor vehicle, the actuator device is preferably only equipped with a single acting magnet. According to a further aspect of the invention, the actuator device is alternatively or additionally used to embody a fuel injection valve, in particular an intake manifold fuel injection valve.

A preferred exemplary embodiment of the actuator device is characterized in that said actuator device comprises a biproportional magnet having two coils that are disposed radially outside of the pole tube and so as to partially overlap with the armature in the axial direction. If current is passed through the first coil, the armature is then pulled in a first direction. If current is passed through the second coil, the armature is then pulled in a second direction which is opposite to the first direction.

The armature is preferably mechanically coupled to a tappet. The tappet advantageously serves to embody a control valve. The armature together with the tappet is preferably clamped between two springs, by means of which the armature is preloaded into a center position.

### BRIEF DESCRIPTION OF THE DRAWINGS

Further advantages, features and details of the invention ensue from the following description, in which different exemplary embodiments are described in detail with reference to the drawings.

In the drawings:

FIG. 1 shows a simplified depiction of an actuator device having a biproportional electromagnet;

FIG. 2 shows an armature for the actuator device from FIG. 1 in longitudinal section according to one exemplary embodiment;

FIG. 3A shows the armature from FIG. 2 in slotted design in a cross-sectional view;

FIG. 3B shows the armature from FIG. 3A having a slot that is interrupted by a web in a cross-sectional view;

FIG. 4 shows a perspective view of an armature according to a further exemplary embodiment comprising plastic encapsulations in two longitudinal sections;

FIG. 5 shows the armature from FIG. 4 in longitudinal section;

FIG. 6 shows a similar armature as in FIG. 4 which is extrusion-coated with plastic in three peripheral sections;

FIG. 7 shows the armature from FIG. 6 in cross section;

FIG. 8 shows a simplified depiction of an assembled pole tube in longitudinal section;

FIG. 9 shows a similar pole tube as in FIG. 8 according to a further exemplary embodiment;

FIG. 10 shows a crenellated profile for depicting inserts;

FIG. 11 shows the profile from FIG. 10 in a rolled state;

FIG. 12 shows an actuator device similar to that in FIG. 1 comprising a dimensionally rigid sleeve to embody a pole tube;

FIG. 13 shows an exploded view of the actuator device from FIG. 12 and

FIG. 14 shows a perspective view of a coil comprising winding ends that are enclosed by an elastic sleeve;

FIG. 15 shows a similar view to that of FIG. 14 according to a further exemplary embodiment;

FIG. 16 shows a similar pole tube as in FIG. 9 according to a further exemplary embodiment and

FIG. 17 shows a simplified depiction of an actuator device comprising a single acting magnet.

### DETAILED DESCRIPTION

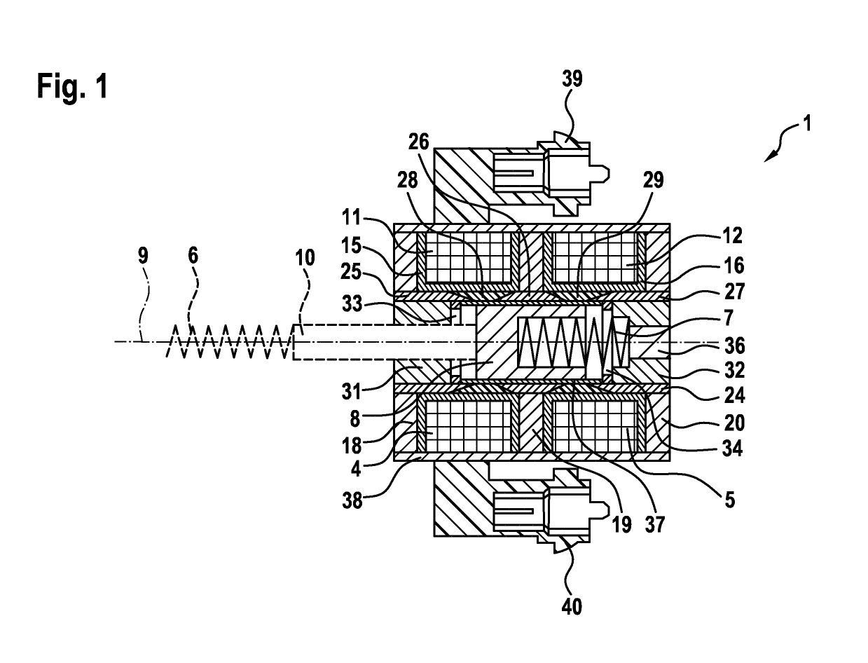

In simplified form, an actuator device 1; 121 is depicted in longitudinal section in FIGS. 1; 12, 13. The actuator device 1; 121 comprises two electromagnets 4, 5; 124, 125 which together constitute a biproportional electromagnet.

An armature 8; 128 can be moved in a reciprocating manner against the preload force of two springs 6, 7; 127. The springs 6, 7; 127 are designed, for example, as helical compression springs. A movement of the armature 8; 128 is transmitted to a tappet 10; 130 which is coupled to the armature 8; 128.

In FIG. 1, it can be seen that the tappet 9 is disposed in the longitudinal direction between the spring 6 and armature 8. The longitudinal direction is defined by the longitudinal axis 9; 129 of the armature 8; 128 or, respectively, of the armature device 1; 121.

The electromagnet 4; 124 is embodied by a first coil 11; 131, which is also referred to as winding. The second electromagnet 5; 125 is analogously embodied by a second coil 12; 132, which is also referred to as winding.

If current is passed through the first coil 11; 131, the armature 8; 128 is moved to the left against the spring preload force of the spring 6 in FIG. 1; 12, 13. If current is passed through the second coil 12; 132, the armature 8; 128 is then moved to the right against the spring preload force of the spring 7; 127 in FIG. 1; 12, 13.

The two coils 11, 12; 131, 132 are wound onto coil carriers 15, 16; 135, 136. Magnetic discs 18 to 20 or magnetic bodies 138 to 140 serve to improve the function of the electromagnets 4, 5; 124, 125.

The magnetic discs 18 to 20 or the magnetic bodies 138 to 140 are associated with a pole tube 24; 144 in which the armature 8; 128 can move in a reciprocating manner. The pole tube 24; 144 comprises magnetic regions 25 to 27; 145 to 147 and amagnetic regions 28, 29; 148, 149.

Internal poles 31, 32; 151, 152 are arranged at the ends in the pole tube 24; 144. The internal poles 31, 32; 151, 152 are used to build up a magnetic flow and are fixedly pressed into the pole tube 24; 144. The armature 8; 128 can be moved in a reciprocating manner between the two internal poles 31, 32; 151, 152.

In order to embody residual air gaps between the armature 8; 128 and the internal poles 31, 32; 151, 152, residual air discs 33, 34; 153, 154 are designed in such a way and disposed at the internal poles 31, 32; 151, 152 in such a way that the armature 8; 128 is prevented from striking against the internal poles 31, 32; 151, 152.

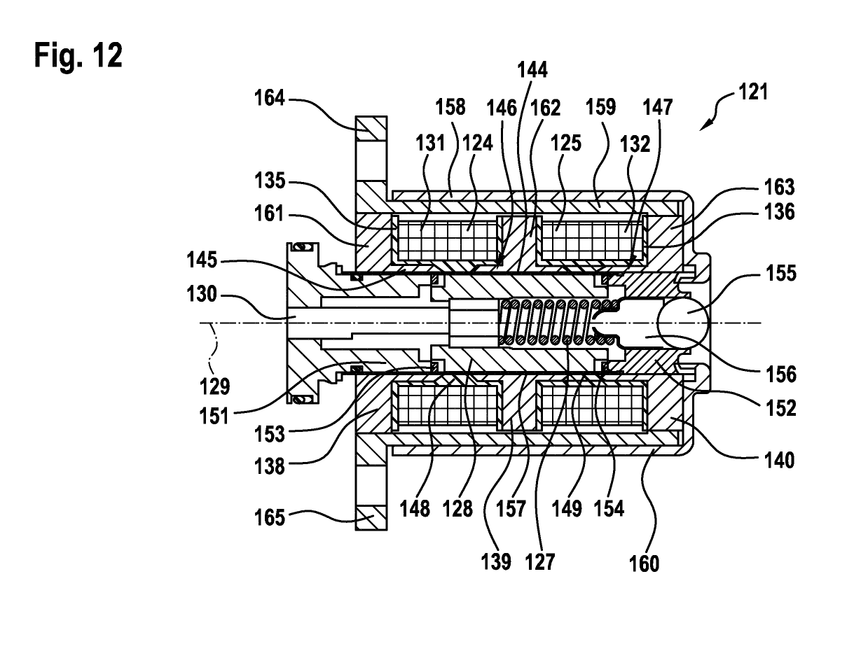

The internal poles 31, 32; 151, 152 are designed as annular bodies. The tappet 10; 130 extends through the internal pole 31; 151. In the exemplary embodiment depicted in FIG. 1, a locking and adjusting element 36 is disposed in the internal pole 32; 152. In the exemplary embodiment depicted in FIG. 12, a locking element 155 and an adjusting element 156 are disposed in the internal pole 152.

The preload force of the spring 7; 127 or, respectively, the center position of the armature 8; 128 can be adjusted via the adjusting element 36; 156. The internal poles 31, 32; 151, 152 are used substantially to pull the armature 8; 128 in the corresponding direction, i.e to the left or to the right, when current is passed through the coils 11, 12; 131, 132.

In the case of the actuator device 1 depicted in FIG. 1, a sliding film 37 is disposed in the radial direction between the armature 8 and the pole tube 24. The sliding film 37 relates, for example, to a Teflon film. Male connectors 39, 40 are mounted to the outside of a housing 38 of the actuator device 1. Said connectors are used to connect electrical cables, by means of which current can be passed through the coils 11, 12.

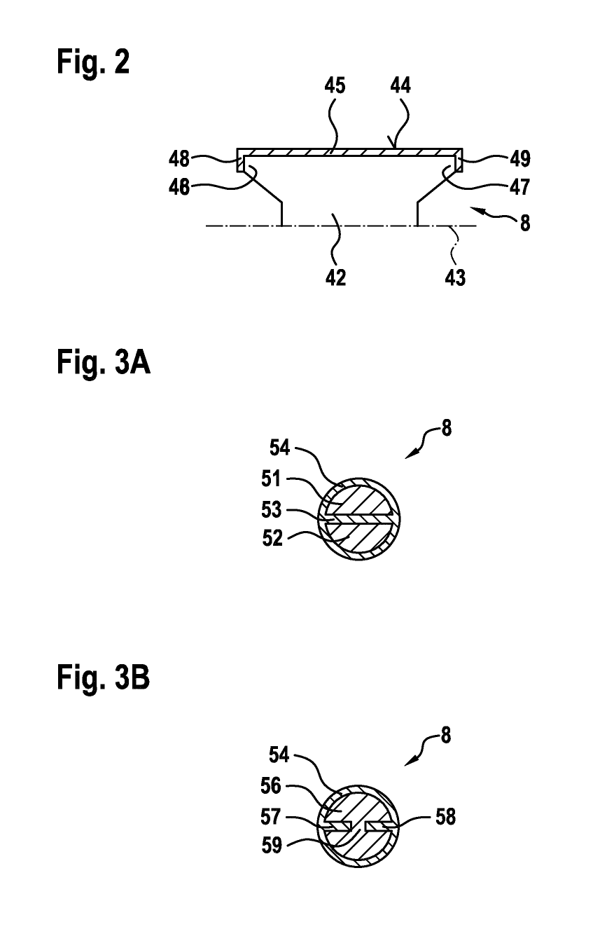

In FIG. 2, the armature 8 of the actuator device 1 from FIG. 1 is depicted in half-section. The armature 8 comprises an armature body 42, which is designed to be rotationally symmetrical about a longitudinal axis 43. The outer radial region of the armature body 42 has the shape of a right circular cylindrical jacket.

In order to provide a radial air gap and to reduce the friction between the armature 8 and the pole tube 24, the armature body 42 is provided with a coating 44 on the outside thereof. The coating 44 constitutes a circular cylindrical jacket 45 which has a very small thickness and surrounds the outer radial region 42 of the armature body 42.

The coating 44 replaces the sliding film which is denoted in FIG. 1 with the reference numeral 37. The size of a radial air gap between the armature 8 and the pole tube 24 can be adjusted via the expansion of the coating 44 or, respectively, of the circular cylindrical jacket 45 in the radial direction.

The coating 44 can be formed from a plastic material, which, for example, comprises polytetrafluoroethylene. The coating 44 can comprise metallic components like chrome or nickel in order to reduce the friction between the armature 8 and the pole tube 24. The coating 44 can be designed as a metallic layer comprising chrome and/or nickel components.

In a particularly advantageous manner, the armature body 42 is extrusion-coated with a plastic material. The plastic material is preferably applied to the armature body during the injection molding process. To this end, the armature body 42 is inserted into a suitable injection mold and extrusion-coated with the plastic material.

In a particularly advantageous manner, end faces formed at the ends 46, 47 of the armature body 42 are likewise extrusion-coated with the plastic material 45. The coating 44 can alternatively also be applied to the end faces at the ends 46, 47 of the armature body 42. The coating 44 or, respectively, the plastic material with which the armature body 42 is extrusion-coated embody annular discs 48, 49 at the ends 46, 47 of the armature body 42.

The annular discs 48, 49 that are integrally connected to the coating 44 or, respectively, the plastic material, which coating or plastic material constitutes the circular cylinder jacket 45, serve the same function as the residual air gap discs 33, 34 in the actuator device 1 depicted in FIG. 1. An axial air gap can be embodied in a simple manner between the armature 8 and the internal poles 31, 32 by means of the annular discs 48, 49. Hence, the residual air gap discs 33, 34 used in the actuator device 1 depicted in FIG. 1 can be omitted.

In FIGS. 3A and 3B, it is shown in each case in cross section that the armature 8 can also be of divided design, in order to reduce eddy currents during operation of the actuator device 1. The armature depicted in FIGS. 3A and 3B is divided, at least partially, into two parts in the longitudinal direction. Otherwise the armature 8 can be similarly or exactly designed as the armature 8 depicted in FIG. 2. That means that a sliding layer and residual air gap discs can be extruded onto the divided armature 8.

In FIG. 3A, the armature 8 is divided by a slot 53 into two equal armature halves 51, 52. The slot extends in the longitudinal direction as well as in the transverse direction completely through the armature 8. The outer radial region of the armature 8 is provided with a coating 54.

In order to position the two armature halves 51, 52 relative to one another, the slot 53 is completely injected with the plastic material. In a particularly preferable manner, the plastic material in the slot 53 is integrally joined with the plastic material that constitutes the coating 54.

It can be seen in FIG. 3B that the armature 8 can also comprise an armature body 56, which is not completely but partially divided. The armature body 56 does not have a continuous slot but two slots 57, 58 that are interrupted by a web 59. The web 59 integrally connects two armature halves of the armature body 56 to one another. The web 59 is centrally disposed in the armature body 56.

In FIGS. 3A and 3B, the armature 8 is injected with plastic material in the slot 53 or slots 57, 58 as well as being completely extrusion-coated with plastic material on the outside.

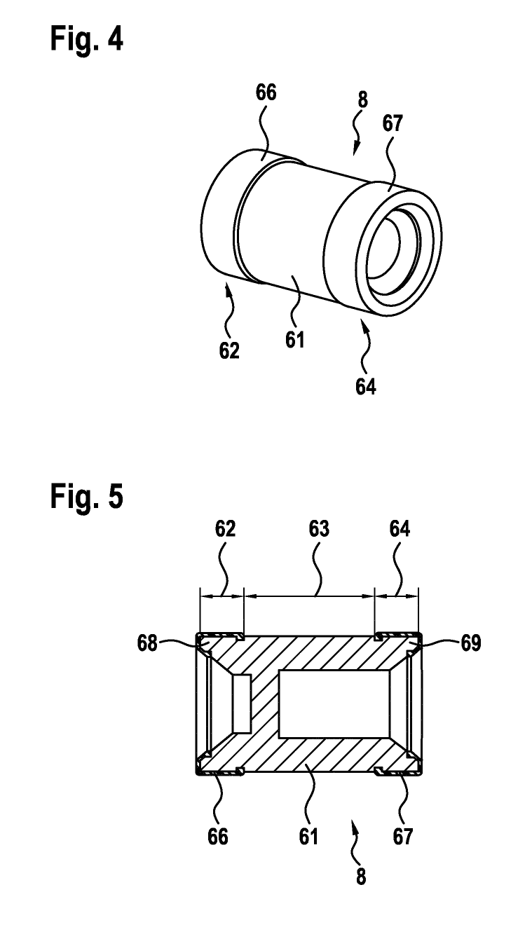

In FIGS. 4 to 7, it is shown that the armature 8 can also be only partially, for example in segments, in particular axially or radially, extrusion-coated with plastic material. In so doing, the partial encapsulation with plastic material is preferably carried out such that a radial air gap as well as axial air gaps are embodied in the armature. In addition, the friction between the armature 8 and the pole tube 24 is reduced by the partial encapsulation with plastic material.

It can be seen in FIGS. 4 and 5 that an armature body 61 is extrusion-coated with plastic material in two longitudinal sections 62 and 64. The longitudinal sections 62, 64 are disposed at the ends 68, 69 of the armature body 61. A longitudinal section 63 is disposed between the two longitudinal sections 62 and 64 and has a greater extension in the longitudinal direction than the two longitudinal sections 62 and 64 together. In order to embody the axial air gaps, the ends 68, 69 of the armature body 61 are also extrusion-coated with plastic material 66, 67.

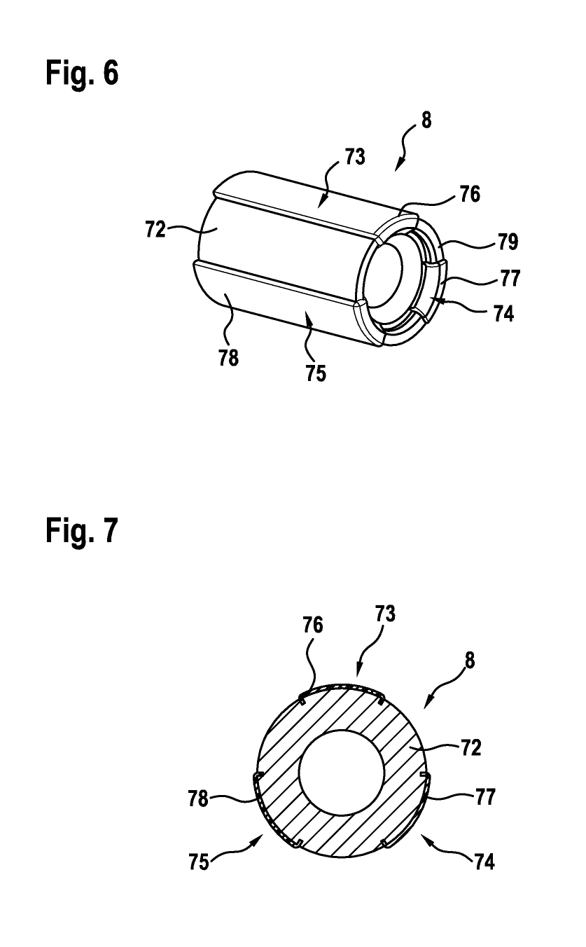

In FIGS. 6 and 7, an armature body 72 is extrusion-coated in three peripheral sections 73 to 75 with plastic material 76 to 78. The peripheral sections 76 to 78 which have been extrusion-coated with the plastic material 76 to 78 are uniformly distributed over the periphery of the armature body 72. In order to embody the axial air gaps, the ends 79, 80 of the armature body 72 are likewise extrusion-coated with the plastic material 76 to 78.

Channels, which enable a hydraulic balance between regions to the right and to the left of the armature 8, result in the peripheral direction between the peripheral sections 73 to 75. The peripheral sections 73 to 75 which have been extrusion-coated with the plastic material 76 to 78 have the same dimensions as the regions which lie between them and have not been extrusion-coated with plastic material.

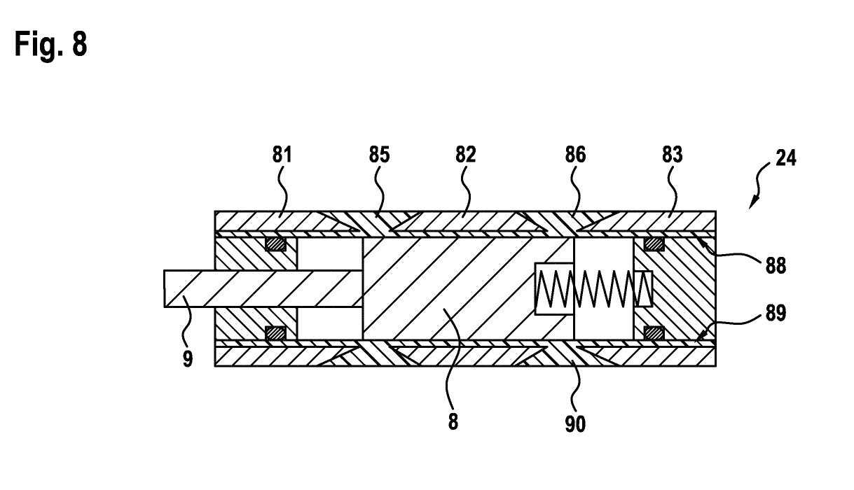

A pole tube 24 comprising magnetic inserts 81 to 83 and amagnetic regions 85, 86 is depicted in FIG. 8 in longitudinal section. The inserts 81 to 83 are designed as annular bodies. The inserted part 82 has a trapezoidal cross section. A longer side of the trapezoidal cross section is disposed in the inner radial region of said pole tube. A shorter side of the trapezoidal cross section is disposed in the outer radial region of said pole tube. The inserts 81 and 83 likewise have trapezoidal cross sections, which are however truncated at the ends of the pole tube 24.

The amagnetic regions 85, 86 likewise have the shape of annular bodies which have in each case a trapezoidal cross section. The longitudinal sides of the trapezoidal cross sections of the amagnetic regions 85, 86 are however disposed in the outer radial region of the pole tube 24. The short sides of the trapezoidal cross sections of the amagnetic regions 85, 86 are disposed on the inside of said pole tube. In so doing, the amagnetic regions 85, 86 are combined with the inserts 81 to 83 such that a pole tube 24 results which has the shape of a right hollow circular cylinder.

The pole tube 24 has an amagnetic region 88 radially within the inserts 81 to 83, which amagnetic region can be embodied by a coating. The amagnetic region has the shape of a right circular cylinder jacket and replaces the sliding film denoted with the reference numeral 37 in FIG. 1. The size of a radial air gap between the armature 8 and the pole tube 24 can be adjusted by means of the dimensions of the amagnetic region 88 in the radial direction. In addition, the inner radial region of the amagnetic region 88 can embody a sliding layer, whereby the friction between the armature 8 and the pole tube 24 is reduced.

In a particularly advantageous manner, the pole tube 24 in FIG. 8 can be produced during the plastic injection molding process. In so doing, the inserts 81 to 83 are placed into a suitable injection mold and positioned therein. The inserts 81 to 83 are subsequently extrusion-coated with a plastic material in order to embody the amagnetic regions 85, 86, 88. It is thereby readily possible for the inner radial region of the inserts 81 to 83 to be completely extrusion-coated with plastic material. At the same time, it is also readily possible by means of an appropriate design of the injection mold for the outer radial region of the inserts 81 to 83 to be free of any plastic material, i.e. not extrusion-coated with any plastic material.

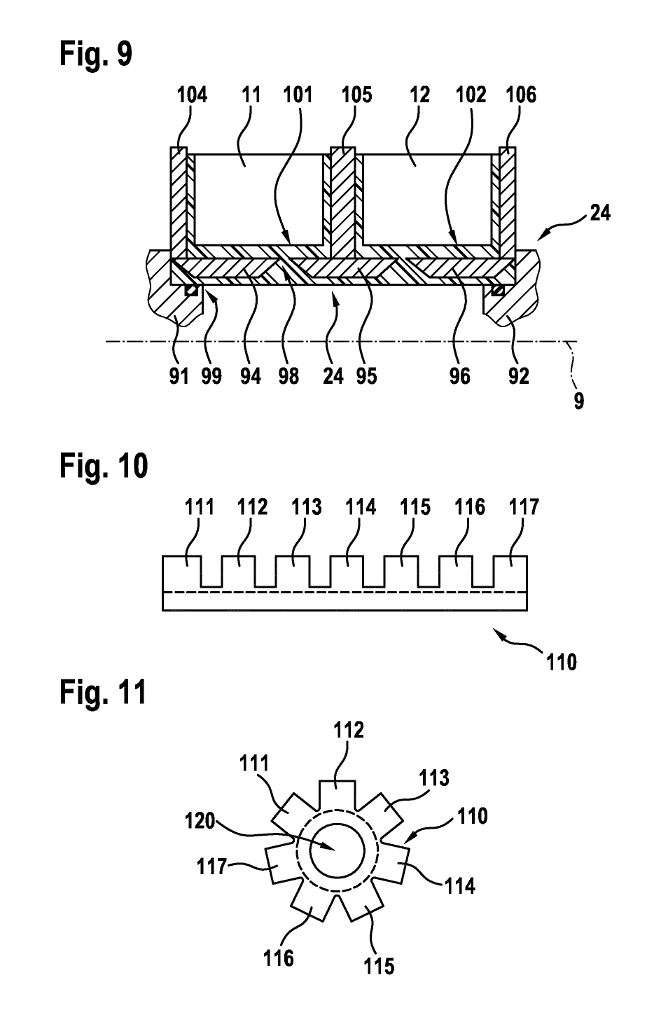

It is shown in FIG. 9 that the inner radial region as well as the outer radial region of the magnetic inserts 94 to 96 of a pole tube 24 can be extrusion-coated with plastic material 98. The plastic material 98 radially within the inserts 94 to 96 is used to embody a sliding layer 99 for an armature that is not depicted. In addition, the plastic material 98 radially within the magnetic inserts 94 to 96 is used to embody a radial air gap between the armature and the pole tube 24. The pole tube 24 is positioned in FIG. 9 by means of housing bodies 91, 92 which are only partially depicted.

In the case of the pole tube 24 depicted in FIG. 9, the plastic material 98, with which the outer radial region of the magnetic inserts 94 to 96 is extrusion-coated, is additionally used to embody coil carriers 101, 102. The coil carriers 101, 102, which can also be referred to as winding carriers, have in each case a U-shaped cross section that is open to the outside. The coil carriers 101, 102 are used to accommodate the coils 11, 12.

The plastic material 98 with regard to the pole tube 24 depicted in FIG. 9 is furthermore used to support or to position magnetic discs 104 to 106. The two magnetic discs 104 and 106 are disposed at the ends of the pole tube 24 and are partially supported on the housing bodies 91, 92. The magnet disc 104 extends radially outwards from the insert 94. The magnet disc 106 extends between the two coils 11 and 12 radially outwards from the insert 95. Axial gaps between the magnetic discs 104 to 106 and the coils 11, 12 are injection molded with the plastic material 98. The injection molding or, respectively, extrusion-coating with the plastic material 98 to embody the coil carriers 101, 102 takes place, however, prior to the winding of the coils 11 and 12.

The inserts 94 to 96 can be designed as turned parts or stamped parts. It is shown in FIGS. 10 and 11 that the inserts 94 to 96 can also be formed from a crenellated profile 110. The crenellated profile 110 comprises in total seven crenellations 111 to 117, which can be used to embody inserts. The straight profile in FIG. 10 is rolled in order to embody the inserts, as can be seen in FIG. 11. A receiving area 120 for an armature can be simply embodied by means of the rolling. In order to embody the inserts, the crenellations 111 to 117 are uniformly distributed in the peripheral direction and protrude radially outwards from the receiving area 120.

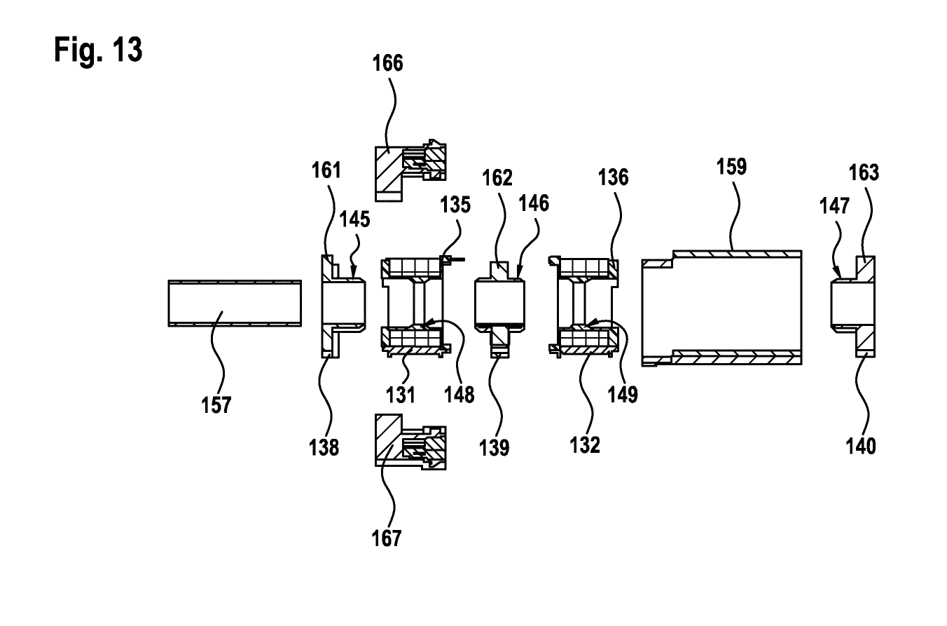

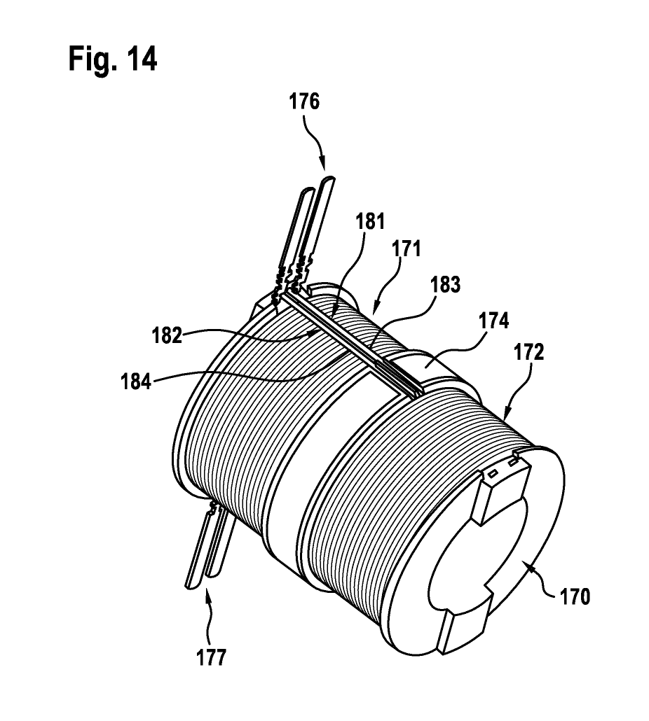

The actuator device 121 depicted in FIGS. 12 and 13 comprises a dimensionally rigid sleeve 157 on which the pole tube 144 is arranged. The sleeve 157 has the shape of a right circular cylinder jacket and replaces inter alia the sliding film 37 of the actuator device 1 depicted in FIG. 1. The sleeve 157 is furthermore used for the arrangement of further functional parts, as is explained below. The sleeve 157 can thereby be formed from an amagnetic or magnetic material. Said sleeve 157 can also be formed from an amagnetic and a magnetic material. If said sleeve 157 is formed entirely or partially from a magnetic material, the inner radial region of the sleeve 157 can then be provided with a coating. The coating can, for example, comprise polytetrafluoroethylene and serve to embody a residual air gap in the radial direction.

The magnetic bodies 138 to 140 comprising the magnetic regions 145 to 147 and the amagnetic regions 148, 149 are arranged on the sleeve 157. In so doing, the magnetic regions 145 to 147 and the amagnetic regions 148 149 embody annular bodies, which together with the sleeve 157 constitute the pole tube 144.

The magnetic annular bodies embodied by the magnetic regions 145 to 147 are integrally connected to respectively one magnetic disc 161 to 163. The magnetic discs 161 to 163 extend radially from the respective magnetic annular body 145 to 147 to the outside. The magnetic bodies 138 to 140 are, for example, produced as turned parts from a metallic material that is magnetic or can be magnetized.

The annular bodies embodied by the amagnetic regions 148 and 149 are integrally connected in each case to one of the two coil carriers 135, 136. In so doing, the coil carriers 135, 136 comprising the amagnetic annular bodies 148, 149 are designed as injection molded parts from a plastic material. A pole tube 144 can thus be created in a simple manner, which not only comprises the magnetic regions 145 to 147 and the amagnetic regions 148, 149 but is additionally combined with the coil carriers 135, 136 and the magnetic discs 161 to 163. As a result, the sleeve 157 serves in a particularly advantageous manner to seal off a receiving area for the armature 128.

The actuator device 121 comprises a housing 158 including a housing body 159 and a further housing body 160. The housing body 159 relates to a magnet pot which surrounds the coils 131 and 132 and enables a magnetic flow or a magnetic reflux. The housing body 160 relates, for example, to an encapsulation with plastic.

Bolt-on connectors 164, 165 extend radially outwards from the housing body 159. The bolt-on connectors 164, 165 serve to fasten the actuator device 121 to a support structure. The male connectors 166, 167 are used to connect the coils 131 and 132 to electrical power supply lines.

A coil carrier 170 comprising two coils 171 and 172 is depicted in FIG. 14. The coils 171, 172 are used in an actuator device 1; 121 to embody electromagnets 4, 5; 124, 125. A divided magnetic disc 174 is disposed between the coils 171, 172.

A pair of electrical terminals 176, 177 is used to connect the coils 171 and 172 to electrical power supply lines. The two electrical terminals 176, 177 are connected to winding ends 181, 182 of the coil 172. The winding ends 181, 182 run from the coil 172 to the terminals 176, 177. In so doing, the two winding ends 181, 182 are disposed in an outer radial region of the coil 172. The winding ends 181, 182 extend in the axial direction, i.e. transversely to the winding direction of the two coils 171, 172.

The two winding ends 181, 182 are each disposed in a sleeve 183, 184. The sleeves 183, 184 are designed as elastic sleeves and are used to reduce stresses due to thermal expansions in the installed state of the coils 171, 172. During extrusion-coating, the coil carrier 170 including the coils 171, 172 wound thereon is extrusion-coated with a plastic material. Finally, the elastic sleeves 183, 184 additionally serve to reduce stresses which result from vibrations during operation of the coils 171, 172 in an actuator device. The elastic sleeves 183, 184 are preferably pushed onto the winding ends 181, 182 prior to being connected to the terminals 176, 177.

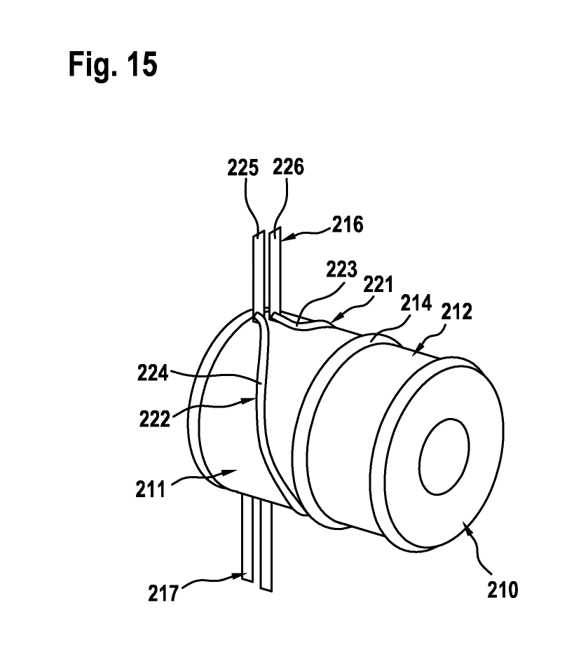

A coil carrier 210 is shown in a perspective view in FIG. 15, said coil carrier being designed similarly to the coil carrier 170 in FIG. 14. The coil carrier 210 likewise comprises two coils 211, 212, a magnetic disc 214 and two terminals 216, 217.

The two terminals 216, 217 each comprise two male connectors 225, 226. The terminal 217 belongs to the coil 211. The terminal 216 belongs to the coil 212. Two winding ends 221, 222 extend from the coil 212 to the male connectors 226, 225. In so doing, the winding ends 221, 222 run on the outside of the coil 211. The winding endings 221, 222 do not, however, run transversely to the coil 211 as in the preceding exemplary embodiment but obliquely thereto. The two winding ends 221, 222 are thereby surrounded in each case by an elastic sleeve 223, 224 as in the preceding exemplary embodiment.

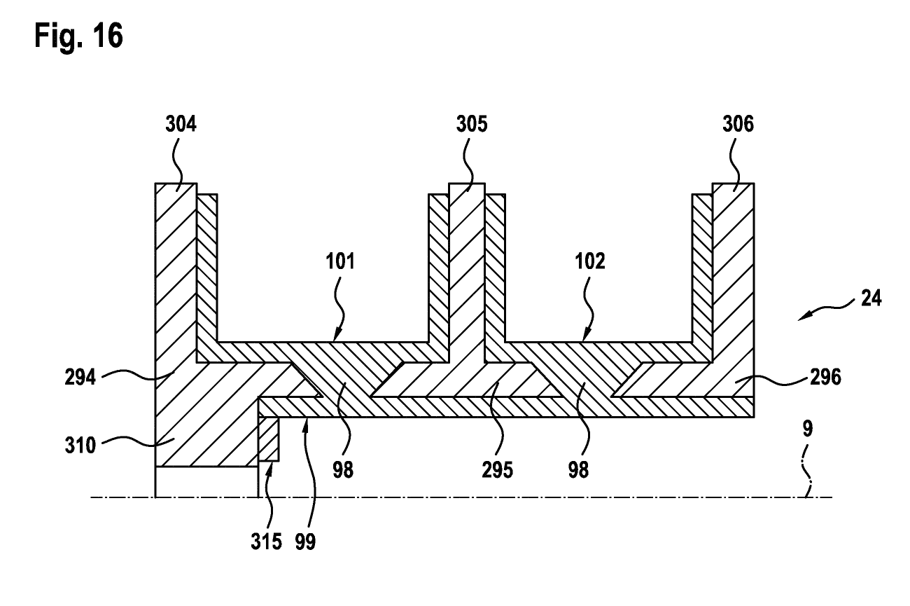

A pole tube 24 similar to that in FIG. 9 is depicted in FIG. 16. The pole tube 24 depicted in FIG. 16 comprises inserts 294, 295 and 296, inner radial regions as well as outer radial regions of which are partially extrusion-coated with plastic material 98. In the exemplary embodiment depicted in FIG. 16, the plastic material 98 serves the same function as in the exemplary embodiment depicted in FIG. 9.

In contrast to the exemplary embodiment depicted in FIG. 9, the inserts 294, 295 and 296 are designed somewhat differently in the case of the pole tube 24 depicted in FIG. 16. The inserts 294 to 296 also have in fact a trapezoidal cross section, the long sides of which are disposed however in the inner radial region of the pole tube and not in the outer radial region as in the exemplary embodiment depicted in FIG. 9. This has proven to be advantageous with regard to the magnetic flux.

In addition, the inserts 294 to 296 are each integrally connected to a magnetic disc 304, 305, 306. The magnetic discs 304, 305, 306 extend radially outwards from the respective insert 294 to 296.

The insert 294 is additionally integrally connected to an internal pole 310. The internal pole 310 together with the insert 294 and the magnetic disc 304 is partially extrusion-coated with the plastic material 98.

In addition, a residual air gap disc 315 is injection-molded onto the internal pole 310. The residual air gap disc 315 is used to embody an axial residual air gap between the internal pole 310 and an armature that is not depicted in FIG. 16.

The residual air disc can, otherwise than depicted, be formed from the plastic material 98. This has the advantage that the pole tube 24 comprising the inserts 294 to 296, the magnetic annular discs 304 to 306 and the internal pole 310 can be produced together with the residual air gap disc 315 in an injection molding process.

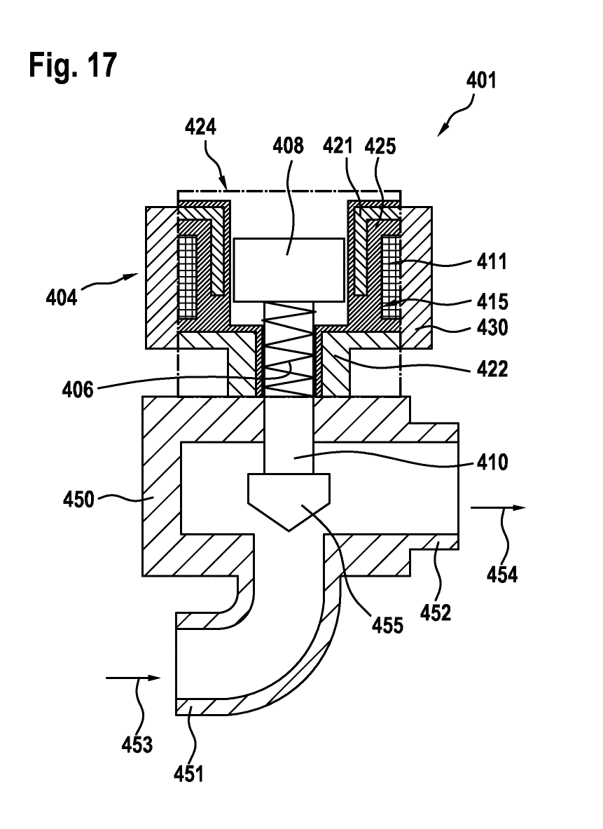

In FIG. 17, an actuator device 401 comprising a single acting electromagnet 404 is depicted in a simplified manner. An armature 408 is preloaded into the depicted open state thereof by a spring 406.

The single acting electromagnet 404 comprises a coil 411. If current is passed through the coil 411, the armature 408 is then pulled downwards against the preload force of the spring 406 in FIG. 17. The coil 411 is disposed in a coil carrier 415. The coil carrier 415 is integrated into a pole tube 424 in a similar manner as in the exemplary embodiments depicted in FIGS. 9 and 16.

The pole tube 424 comprises combination bodies 421; 422 which are partially extrusion-coated with a plastic material 425. As shown in the exemplary embodiment depicted in FIG. 16, the combination bodies 421; 422 comprise in each case an insert which is integrally connected to a magnetic disc.

The plastic material 425 which is used to extrusion-coat the combination bodies 421; 422 simultaneously serves to embody the coil carrier 415 in a particularly advantageous manner. The coil carrier 415 is closed on the outside by a magnet pot or yoke body 430.

The actuator device 401 is associated with a cooling and/or heating circuit, in particular a water circuit, of a motor vehicle. The water circuit comprises a housing 450 having an inlet 451 and an outlet 452.

Incoming coolant is indicated by an arrow 453. Outgoing coolant is indicated by an arrow 454.

A connection between the inlet 451 and the outlet 452 can be interrupted by a closing body 455. The closing body 455 is mounted to an end of the tappet 410 that faces away from the armature 408.

If current is passed through the electromagnet 404 or, respectively, the coil 411, the armature 408 in FIG. 17 is then pulled downwards in such a way that the closing body 455 closes the connection between the inlet 451 and the outlet 452. As soon as current is no longer passed through the electromagnet 404 or, respectively, the coil 411, the preload force of the spring ensures that the armature 408 including the closing body 455 is again moved into the open position thereof depicted in FIG. 17.

1. An armature for an actuator device (1; 401) comprising at least one magnet (4, 5), characterized in that an outer radial region of the armature (8) is provided with a coating.

2. The armature according to claim 1, characterized in that the coating (44) has a constant extension in a radial direction.

3. The armature according to claim 1, characterized in that the coating (44) is a slide coating.

4. The armature according to claim 1, characterized in that the coating (44) is formed from a friction reducing material.

5. The armature according to claim 1, characterized in that the outer radial region of the armature (8) is extrusion-coated with a plastic material.

6. The armature according to claim 1, characterized in that the outer radial region of the armature (8) is provided with a metallic layer which contains chrome.

7. The armature according to claim 1, characterized in that the outer radial region of the armature (8) is provided with a metallic layer which contains nickel.

8. The armature according to claim 1, characterized in that the outer radial region of the armature (8) is provided with the coating over an entire longitudinal extension thereof.

9. The armature according to claim 1, characterized in that the outer radial region of the armature has at least one section that is not provided with the coating or encapsulation.

10. The armature according to claim 9, characterized in that the section not provided with the coating or encapsulation enables a hydraulic balance between two opposite ends of the armature.

11. An actuator device comprising an armature (8) according to claim 1, which armature is configured to be moved in a pole tube (24) in a reciprocating manner in a longitudinal direction.

12. The actuator device according to claim 11, characterized in that the actuator device (1; 401) comprises a biproportional magnet (4, 5) having two coils (11, 12) which are disposed radially outside of the pole tube (24; 424) and so as to partially overlap with the armature (8; 408) in an axial direction.
